(19) United States
(12) Patent Application Publication
(10) Pub. No.: US 2005/0104367 A1
(43) Pub. Date: May 19, 2005

(54) Attachment ring for a tube-connecting device

(75) Inventor: Philippe Le Quere, Betton (FR)

Correspondence Address: YOUNG & THOMPSON, 745 SOUTH 23RD STREET, 2ND FLOOR, ARLINGTON, VA, 22202, US

(73) Assignee: LEGRIS SA, RENNES (FR)

(21) Appl. No.: 10/502,747

(22) PCT Filed: Feb. 5, 2003
(86) PCT No.: PCT/FR03/00351

(30) Foreign Application Priority Data
Feb. 11, 2002 (FR) 02 01620

(51) Int. Cl. F16L 35/00

(52) U.S. Cl. 285/18

(57) ABSTRACT

A fastener washer for a tube coupling device, the washer being deformable and having an inside circumference subdivided into a plurality of teeth (2) each possessing an active portion (3) connected via an intermediate portion (4) to a root portion (5), the intermediate portion being defined laterally by two parallel edges (9), and the active portion having a width (A) that is greater than a width (C) of the intermediate portion between the two parallel edges.

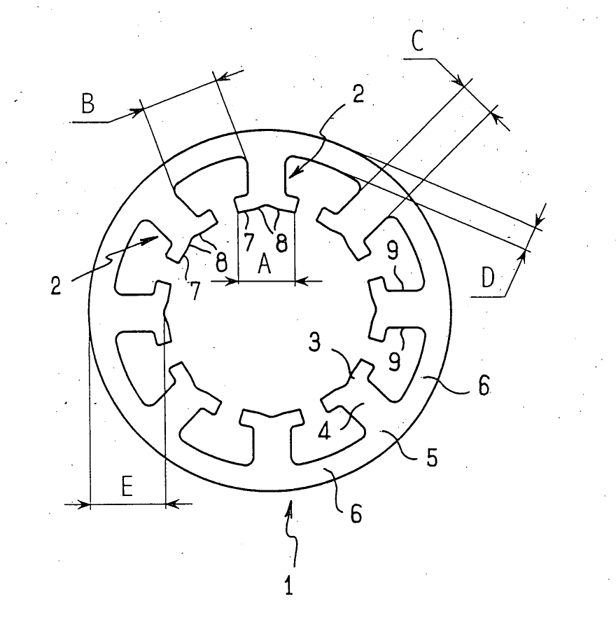

The present invention relates to a fastener washer for a coupling device, such as a quick connection coupling usable in a circuit for conveying fluid, in particular for connecting one tube to another tube, to a fluid-delivery element, such as a pump, or to a fluid-receiver element, such as a tank.

### BACKGROUND OF THE INVENTION

A coupling device of known type generally comprises a body provided with a bore for receiving one end of a tube, and means for retaining the tube in the bore. These means comprise an elastically deformable washer possessing an inside circumference with a diameter that is smaller than the outside diameter of the tube, and that is subdivided into a plurality of teeth, and an outer portion that is received in a groove formed in the bore.

While the tube is being inserted, the teeth are lifted by bending to allow the tube to pass, and under the effect of the elasticity of the material constituting the washer, the free end of each tooth is pressed against the outside surface of the tube. When an extraction force is exerted on the tube, or when the circuit including the coupling device is put under pressure, the tube begins to move in reverse, and this movement is stopped when the free ends of the teeth bite into the outside surface of the tube and the teeth jam and oppose the force exerted on the tube.

There exist teeth which are defined by radial slots and which are generally trapezoidal in shape having a small base on the inside of the washer. The free ends of the teeth for engaging against the outside surface of the tube are then of relatively large size, which provides effective retention of the tube. However, a washer made in that way is very rigid so that it is difficult to insert the tube, and the teeth tend to scratch its outside surface.

To obviate that drawback, proposals have been made to increase the length of the connecting portions interconnecting the teeth. The teeth are generally trapezoidal in shape with their large bases disposed on the inside of the washer. The length of the free end edge is then smaller than for the above-described washer, such that the ability of the tube to withstand being pulled out is reduced. In addition, that shape leads to zones in which said stresses are concentrated where the teeth join the connection portions, such that washers of that type present poor endurance.

### OBJECT OF THE INVENTION

There thus exists a need that is not satisfied in convenient manner at present, for a fastener washer which provides firm retention of the tube, which is long-lasting, and which makes it relatively easy to insert the tube into the coupling device.

### BRIEF SUMMARY OF THE INVENTION

To this end, the invention provides a fastener washer for a tube coupling device, the washer being deformable and having an inside circumference subdivided into a plurality of teeth each possessing an active portion connected via an intermediate portion to a root portion, the intermediate portion being defined laterally by two parallel edges, and the active portion being of a width greater than a width of the intermediate portion between the two parallel edges.

Thus, the shape of the active portion makes it possible to obtain a large contact zone between the tooth and the tube. This shape of tooth also provides good distribution of stresses, thereby improving the endurance of the washer. Furthermore, the connection portions are of relatively great length, such that the connection portions are of flexibility that is adapted to the movements of the teeth.

Other characteristics and advantages of the invention will appear on reading the following description of a particular and non-limiting embodiment of the invention.

### BRIEF DESCRIPTION OF THE DRAWING

Reference is made to the sole accompanying FIGURE which is a front view of a fastener washer in accordance with the invention.

### DETAILED DESCRIPTION OF AN EMBODIMENT OF THE INVENTION

The fastener washer described herein is for fitting to a coupling device for coupling a metal or plastics tube to a fluid-conveying circuit element such as another tube, a fluid-delivering member, or a fluid-receiver member . . . . The coupling device comprises a body provided with a bore for receiving one end of the tube and means for retaining the tube in the bore, with the fastener washer forming part of said means. The fastener washer is received, for example, in a groove formed in the bore.

The fastener washer in accordance with the invention is preferably made of a material that is elastically deformable, e.g. stainless steel.

With reference to the FIGURE, the fastener washer given overall reference 1 is, in this case, generally frustoconical and annular in shape, with an inside circumference that is subdivided into a plurality of teeth given overall reference 2, each tooth comprises an active portion 3 for engaging the outside surface of the tube, which active portion is connected to a root portion 5 via an intermediate portion 4.

The intermediate portion 4 is defined laterally by two parallel edges 9. Each tooth is thus generally T-shaped with the crossbar of the T-shape being formed by the active portion 3 which is located towards the inside of the washer.

The root portions 5 are interconnected by connection portions 6.

The width A of the active portion 3 is not less than 4/3rds the width C (measured between the edges 9) of the intermediate portion 4, and not greater than about twice the width C of the intermediate portion 4.

The connection portions 6 are of width D lying in the range 0.5 to 1.0 times the width C of the intermediate portions.

Where the intermediate portions 4 are connected to the root portions 5, they are spaced apart from one another by a distance B of not less than about the width A of the active portions 3.

The teeth 2 are of a length E that is substantially equal to the distance B between the intermediate portions 4 where they join the root portions 5.

It should be observed that each active portion 3 in this case has a terminal edge 7 which includes cramping points 8.

The cramping points 8 are made by making a circularly-arcuate cutout in the edge 7 so as to form two cramping points 8. The cramping points 8 could be made differently, for example by cutouts of triangular or rectangular . . . shape, and the number of clamping points may likewise be other than two.

Naturally, the invention is not limited to the embodiment described, and variants can be applied thereto without going beyond the ambit of the invention as defined by the claims.

In particular, the ratios of the dimensions given above can be modified to adapt the retaining force exerted by the washer on the material constituting the tube so as to satisfy particular constraints of endurance or so as to increase or reduce the force that needs to be exerted on the tube in order to insert it into the coupling device.

1. A fastener washer for a tube coupling device, the washer being deformable and having an inside circumference subdivided into a plurality of teeth (2) each possessing an active portion (3) connected via an intermediate portion (4) to a root portion (5), wherein the intermediate portion is defined laterally by two parallel edges (9), and wherein the active portion is of a width (A) greater than a width (C) of the intermediate portion between the two parallel edges.

2. A fastener washer according to claim 1, wherein the length (A) of the active portion (3) is not less than 4/3rds the width (C) of the intermediate portion (4).

3. A fastener washer according to claim 1, wherein the width (A) of the active portion (3) is not more than about twice the width (C) of the intermediate portion (4).

4. A fastener washer according to claim 1, wherein the root portions (5) are connected to one another by connection portions (6) of width (D) lying in the range 0.5 to 1.0 times the width (C) of the intermediate portions (4).

5. A fastener washer according to claim 1, wherein the intermediate portions (4) are spaced apart where they join the root portions (5) by a distance (B) that is not less than about the width (A) of the active portions (3).

6. A fastener washer according to claim 5, wherein the teeth (2) are of a length (E) that is substantially equal to the distance (B) between the intermediate portions (5) where they join the root portions (5).
